(19) United States
(12) Patent Application Publication
(10) Pub. No.: US 2019/0203859 A1
(43) Pub. Date: Jul. 4, 2019

(54) PIPE SPLICING ASSEMBLY

(71) Applicant: Nathaniel Shackelford, Montgomery, AL (US)

(72) Inventor: Nathaniel Shackelford, Montgomery, AL (US)

(21) Appl. No.: 15/857,064

(22) Filed: Dec. 28, 2017

(51) Int. Cl. F16L 21/03

(52) U.S. Cl. CPC F16L 21/03

(57) ABSTRACT

A pipe splicing assembly for splicing a pipe includes a first sleeve that insertably receives a first pipe such that the first sleeve is in fluid communication with the first pipe. A second sleeve provided and the second sleeve is slidably positioned in the first sleeve. Thus, each of the first sleeve and the second sleeve are positionable to have a length ranging between a minimum length and a maximum length. The second sleeve insertably receives a second pipe such that the second sleeve is in fluid communication with the second pipe. In this way the first pipe is spliced with and is in fluid communication with the second pipe. A gasket is coupled to the second sleeve to form a fluid impermeable seal between the first sleeve and the second sleeve.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to splicing devices and more particularly pertains to a new splicing device for splicing a pipe.

### BRIEF SUMMARY OF THE INVENTION

An embodiment of the disclosure meets the needs presented above by generally comprising a first sleeve that insertably receives a first pipe such that the first sleeve is in fluid communication with the first pipe. A second sleeve provided and the second sleeve is slidably positioned in the first sleeve. Thus, each of the first sleeve and the second sleeve are positionable to have a length ranging between a minimum length and a maximum length. The second sleeve insertably receives a second pipe such that the second sleeve is in fluid communication with the second pipe. In this way the first pipe is spliced with and is in fluid communication with the second pipe. A gasket is coupled to the second sleeve to form a fluid impermeable seal between the first sleeve and the second sleeve.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pipe splicing assembly according to an embodiment of the disclosure.

FIG. 2 is an exploded perspective view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

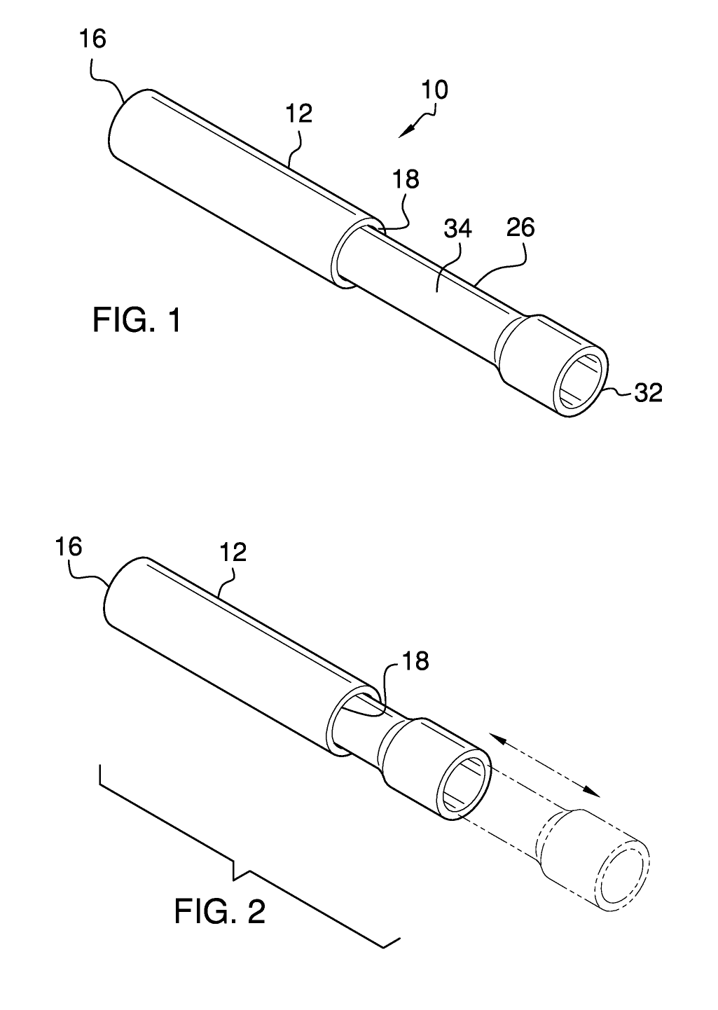

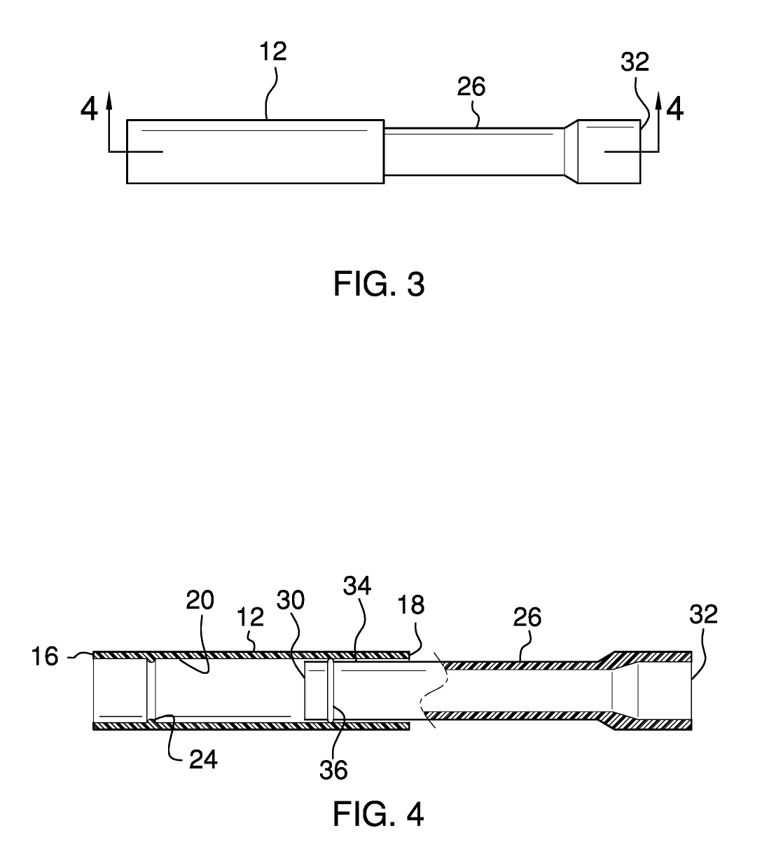

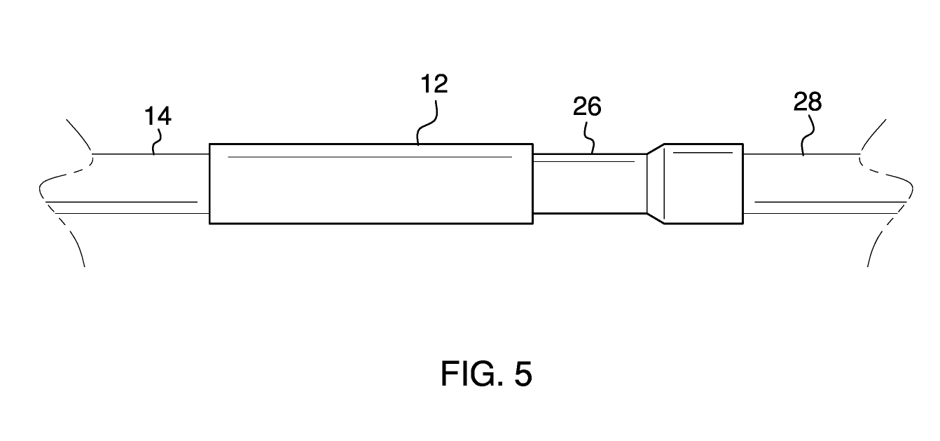

With reference now to the drawings, and in particular to FIGS. 1 through 5 thereof, a new splicing device embodying the principles and concepts of an embodiment of the disclosure and generally designated by the reference numeral 10 will be described.

As best illustrated in FIGS. 1 through 5, the pipe splicing assembly 10 generally comprises a first sleeve 12 that insertably receives a first pipe 14 such that the first sleeve 12 is in fluid communication with the first pipe 14. The first pipe 14 may be a buried water pipe or the like and the first pipe 14 may be comprised of PVC. The first sleeve 12 has a first end 16, a second end 18 and an inner surface 20 extending therebetween. Additionally, the first sleeve 12 may have a length ranging between approximately 25.0 cm and 30.0 cm and an inside diameter ranging between approximately 5.0 cm and 15.0 cm. The first sleeve 12 may be comprised of schedule 40 PVC or other fluid impermeable material.

A prominence 24 is positioned on the inner surface 20 of the first sleeve 12. The prominence 24 is continuous such that the prominence 24 forms a closed loop extending around the inner surface 20. Additionally, the prominence 24 is positioned closer to the first end 16 than the second end 18 and the first end 16 insertably receives the first pipe 14.

A second sleeve 26 is provided and the second sleeve 26 is slidably positioned in the first sleeve 12. Thus, each of the first sleeve 12 and the second sleeve 26 are positionable to have a length ranging between a minimum length and a maximum length. The second sleeve 26 insertably receives a second pipe 28 such that the second sleeve 26 is in fluid communication with the second pipe 28. In this way the first pipe 14 is in fluid communication with the second pipe 28. The second pipe 28 may be a buried water pipe or the like and the second pipe 28 may be comprised of PVC. The second sleeve may have a length ranging between approximately 25.0 cm and 30.0 cm. Thus, first sleeve and the second sleeve may be adjusted to a combined length ranging between approximately 30.0 cm and 55.0 cm.

The second sleeve 26 has a primary end 30, a secondary end 32 and an outer wall 34 extending therebetween. The second end 18 of the first sleeve 12 insertably receives the primary end 30 of the second sleeve 26. Additionally, the outer wall 34 flares outwardly adjacent to the secondary end 32 such that the secondary end 32 has a diameter that is greater than a diameter of the primary end 30. In this way the secondary end 32 has a diameter that is sufficient to insertably receive the second pipe 28.

A gasket 36 is positioned around the outer wall 34 of the second sleeve 26 and the gasket 36 is continuous such that the gasket 36 forms a closed loop. The gasket 36 frictionally engages the inner surface 20 of the first sleeve 12 and the gasket 36 forms a fluid impermeable seal with the first sleeve 12. In this way the gasket 36 inhibits fluid delivered from the first pipe 14 from passing between the first sleeve 12 and the second sleeve 26. Additionally, the gasket 36 abuts the prominence 24 when the first sleeve 12 is fully inserted into the second sleeve 26. In this way the gasket 36 retains the first sleeve 12 and the second sleeve 26 at the minimum length.

In use, the first pipe 14 and the second pipe 28 may be defined by cutting a damaged length out of an existing pipe. Thus, the first pipe 14 is spaced from and is aligned with the second pipe 28. The second sleeve 26 is fully inserted into the first sleeve 12 and the first end 16 of the first sleeve 12 is slid onto the first pipe 14. The first sleeve 12 is bonded to the first pipe 14 with PVC glue or any other adhesive appropriate for the material comprising the first pipe 14 and the first sleeve 12. The second sleeve 26 is urged outwardly from the first sleeve 12 until the secondary end 32 of the second sleeve 26 insertably receives the second pipe 28. Additionally, the second sleeve 26 is bonded to the second pipe 28 with PVC glue or any other adhesive appropriate for the material comprising the second pipe 28 and the second sleeve 26. In this way the first pipe 14 and the second pipe 28 are fluidly spliced together.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pipe splicing assembly being configured to join two sections of pipe, said assembly comprising:
a first sleeve being configured to insertably receive a first pipe such that said first sleeve is in fluid communication with the first pipe;
a second sleeve being slidably positioned in said first sleeve such that each of said first sleeve and said second sleeve are positionable to have a length ranging between a minimum length and a maximum length, said second sleeve being configured to insertably receive a second pipe such that said second sleeve is in fluid communication with the second pipe thereby facilitating the first pipe to be in fluid communication with the second pipe; and
a gasket being coupled to said second sleeve, said gasket forming a fluid impermeable seal between said first sleeve and said second sleeve.

2. The assembly according to claim 1, wherein said first sleeve has a first end, a second end and an inner surface extending therebetween, said inner surface having a prominence thereon, said prominence being continuous such that said prominence forms a closed loop extending around said inner surface, said prominence being positioned closer to said first end than said second end, said first end being configured to insertably receive the first pipe.

3. The assembly according to claim 2, wherein said second sleeve has a primary end, a secondary end and an outer wall extending therebetween, said second end of said first sleeve insertably receiving said primary end of said second sleeve.

4. The assembly according to claim 3, wherein said outer wall flares outwardly adjacent to said secondary end such that said secondary end has a diameter being greater than a diameter of said primary end, said secondary end being configured to insertably receive the second pipe.

5. The assembly according to claim 3, further comprising a gasket being positioned around said outer wall of said second sleeve, said gasket being continuous such that said gasket forms a closed loop, said gasket frictionally engaging said inner surface of said first sleeve such that said gasket forms a fluid impermeable seal with said first sleeve wherein said gasket is configured to inhibit fluid from the first pipe from passing between said first sleeve and said second sleeve.

6. The assembly according to claim 5, wherein said gasket abuts said prominence when said first sleeve is fully inserted into said second sleeve such that said first sleeve and said second sleeve are retained at said minimum length.

7. A pipe splicing assembly being configured to join two sections of pipe, said assembly comprising:
a first sleeve being configured to insertably receive a first pipe such that said first sleeve is in fluid communication with the first pipe, said first sleeve having a first end, a second end and an inner surface extending therebetween, said inner surface having a prominence thereon, said prominence being continuous such that said prominence forms a closed loop extending around said inner surface, said prominence being positioned closer to said first end than said second end, said first end being configured to insertably receive the first pipe;
a prominence being positioned on said inner surface of said first sleeve, said prominence being continuous such that said prominence forms a closed loop extending around said inner surface, said prominence being positioned closer to said first end than said second end, said first end being configured to insertably receive the first pipe;
a second sleeve being slidably positioned in said first sleeve such that each of said first sleeve and said second sleeve are positionable to have a length ranging between a minimum length and a maximum length, said second sleeve being configured to insertably receive a second pipe such that said second sleeve is in fluid communication with the second pipe thereby facilitating the first pipe to be in fluid communication with the second pipe, said second sleeve having a primary end, a secondary end and an outer wall extending therebetween, said second end of said first sleeve insertably receiving said primary end of said second sleeve, said outer wall flaring outwardly adjacent to said secondary end such that said secondary end has a diameter being greater than a diameter of said primary end, said secondary end being configured to insertably receive the second pipe; and
a gasket being positioned around said outer wall of said second sleeve, said gasket being continuous such that said gasket forms a closed loop, said gasket frictionally engaging said inner surface of said first sleeve such that said gasket forms a fluid impermeable seal with said first sleeve wherein said gasket is configured to inhibit fluid from the first pipe from passing between said first sleeve and said second sleeve, said gasket abutting said prominence when said first sleeve is fully inserted into said second sleeve such that said first sleeve and said second sleeve are retained at said minimum length.
